(19) United States
(12) Patent Application Publication
(10) Pub. No.: US 2005/0212913 A1
(43) Pub. Date: Sep. 29, 2005

(54) Method and arrangement for recording regions of interest of moving objects

(75) Inventor: Uwe Richter, Jena (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Smiths Heimann Biometrics GmbH;

(21) Appl. No.: 11/092,002

(22) Filed: Mar. 29, 2005

(30) Foreign Application Priority Data
Mar. 29, 2004 (DE) 10 2004 015 806.1

(51) Int. Cl. H04N 5/225; H04N 5/228; G03B 17/00

(52) U.S. Cl. 348/170; 348/208.14

(57) ABSTRACT

The invention is directed to a method and an arrangement for recording regions of interest in moving objects, preferably of persons. The object of the invention, to find a novel possibility for recording high-resolution electronic images of the faces of persons which achieves high-quality portraits quickly and without manual intervention on the part of the operator with optimal settings of the camera, is met according to the invention in that the image sensor is switchable to a full-image mode and a partial-image mode. An overview recording (such as full image 51) is recorded by a wide-angle objective in the full-image mode and the region of interest (such as face 11) of a person object is recorded in the partial-image mode. The full image is analyzed by an image evaluating unit with regard to the presence and position of object features of a person, a circumscribing rectangle is determined therefrom, and the determined circumscribing rectangle is used as a boundary of a programmable readout window of the image sensor in order to read out a sequence of partial images in the partial-image mode which contain the face of the person so as to fill the image area.

### CROSS-REFERENCE TO RELATED APPLICATIONS

This application claims priority of German Application No. 10 2004 015 806.1, filed Mar. 29, 2004, the complete disclosure of which is hereby incorporated by reference.

### BACKGROUND OF THE INVENTION

a) Field of the Invention

The invention is directed to a method and an arrangement for recording regions of interest in moving objects, preferably of persons, in which a region of interest of the object is tracked with an image that is read out of an image sensor for the output image so as to fill the image area. The invention is preferably applied in personal identification.

b) Description of the Related Art

For purposes of official identity documentation by the police, images of the face (portraits) are recorded in addition to text information (name, date of birth) and fingerprints. These images are used to identify the person and are stored in databases for this purpose so that they are available at a later date for comparing to other images. The comparison serves to show whether a match exists, that is, whether or not the image taken by the identification service and an image used for comparison (for the example, the photograph in a database) show the same person. The image must have appropriate qualitative characteristics in order for this comparison to be conducted with certainty. One of these qualitative characteristics is that the face is contained in the image so as to fill as much of the image area as far as possible and all details (mouth, nose, eyes, hair) are clearly visible. The face must be uniformly well lit for this purpose and photographed in defined poses (front, profile).

Traditionally, these images were made with a photographic camera, but in modem systems electronic cameras are used. In typical configurations, these electronic cameras continuously supply live images and send this stream of images to a computer via an interface. The live image is displayed on the screen of the computer. Accordingly, the user can direct the camera with reference to the live image in such a way and adjust the illumination in such a way that the desired quality of the recording is ensured. When the person being photographed is large, the user can swivel the camera upward in order to capture the face completely so as to fill up the image area; when the person is small, the camera is swiveled down in a corresponding manner. If the face appears too dark on the screen, the user must increase the sensitivity of the camera or, if possible, increase the brightness of the illumination. The user will only store the image when the quality is satisfactory.

For police use, cameras are employed, according to the prior art, that can be swiveled by a motor (upward and downward, right and left) and zoomed (in and out) in the visual field by a motor by means of a control command. The zoom adjustment of the objective of the camera can be set at the start in such a way that the person can be seen in his/her entirety on the live camera image. The user then swivels the camera upward in such a way that the head is centered in the image. The user then zooms in until the head fills the image area of the live image, as is required. The camera can be adjusted by the user manually by means of a camera control. A commercially available camera that is used very often for this purpose is the EVI-D100 by Sony Corp. (Japan).

Occasionally, automated methods are also used to set up a camera of the kind mentioned above. For example, U.S. Pat. No. 6,593,962 describes a system in which the camera is initially directed to a background in a calibrating mode and the zoom setting and center of the background are adjusted to this. A person is then posed in front of the background, a picture is taken with the camera, and the position of the face in this image is determined. The brightness can likewise be adjusted by means of the diaphragm of the objective of the camera. Once all of these adjustments have been made and the arrangement is accordingly calibrated, photographing of persons can commence. The position of the face in the image is then determined and the camera is swiveled downward or upward by computer control.

On the one hand, the known solutions described above are interactive processes for optimizing camera adjustments in which the operator plays the primary role (see also FIG. 3). The quality of the results and the speed with which they are carried out depend on the ability of the operator (e.g., through multiple repetitions of the process). During this time, the attention of the operator is concentrated on these technical adjustments, which can present problems in law enforcement practice if the person being identified is uncooperative and, for example, reacts aggressively.

Also, in case of computer-controlled swiveling adjustments and zoom adjustments of the camera which require motor-operated adjusting mechanisms for the camera and optics, the adjustment process takes some time and may occasionally be very lengthy due to movement on the part of the person or interference factors, e.g., a second person.

### OBJECT AND SUMMARY OF THE INVENTION

It is the primary object of the invention to find a novel possibility for recording high-resolution electronic images of the faces of persons which achieves high-quality portraits quickly and without manual intervention on the part of the operator with optimal settings of the camera. Further, a solution is to be found whereby a plurality of faces can also be captured simultaneously so as to fill the image area in the expanded image field of a wide-angle camera.

In a method for recording regions of interest in moving or changing objects, preferably the faces of persons, in which a region of interest of the object is tracked so as to fill the image area for the output format with an image that is read out of an image sensor, the above-stated object is met, according to the invention, in that the image sensor is operated in such a way that it can be switched sequentially to a full-image mode and a partial-image mode, wherein an image is recorded by a wide-angle objective as a stationary overview recording in the full-image mode and the region of interest of the object is recorded in the partial-image mode, in that the image acquired in the full-image mode is analyzed by means of an image evaluating unit with regard to the presence and position of given object features, preferably of the face of a person, and a circumscribing rectangle around the region of interest of the object defined by the object features that are found is determined from the position of the object features that are found, in that the currently determined circumscribing rectangle is used as a boundary of a programmable readout window of the image sensor, and in that, in partial-image mode, a sequence of partial images in which the region of interest of the object is contained so as to fill the image area is read out at a high image rate based on the currently adjusted readout window of the image sensor.

In an advantageous manner, partial images that are read out in partial-image mode are analyzed to determine whether there is any movement of given object features in successively read out partial images and, when it is determined that there has been a displacement of the object features in one partial image in relation to a preceding partial image, the position of the circumscribing rectangle is displaced in a matching manner in order to keep the region of interest of the object completely within the partial image that is read out subsequently.

It is advisable to switch back to the full-image mode when a border of the rectangle circumscribing the displaced partial image reaches or goes beyond the edge of the full-image recording, and the presence and position of the given object features are determined anew.

In another variant, the full-image mode can be switched back from the partial-image mode when at least one object feature that is used to determine the circumscribing rectangle disappears from the partial image.

It has proven advantageous to determine the brightness of the object feature in the image in addition to its position, to carry out a comparison to a reference brightness defined as optimal and, when there is a divergence from the reference brightness, to adapt the signal acquisition. This is preferably carried out by changing the sensitivity adjustments of the image sensor and/or the gain of the A-D conversion of the image sensor signal. Further, it can be advisable to regulate the electronic shutter speed of the image sensor and/or to change the diaphragm adjustment of the camera.

Further, in a method for recording regions of interests of moving or changing objects, preferably of persons, in which a region of interest of an object is tracked so as to fill the image area for the output format with an image that is read out from an image sensor, the above-stated object is met, according to the invention, in that the image sensor is operated so as to be switchable sequentially to a full-image mode and a partial-image mode, an image is made as a stationary overview recording in the full-image mode and the region of interest of the object is recorded in the partial-image recording mode, in that the image acquired in the full-image recording mode is analyzed by means of an image evaluating unit for the presence and position of given defined object features, preferably faces of persons, and circumscribing rectangles around the regions of interest of all found objects which are defined by the given object features are determined from the position of the given found object features, in that the currently determined circumscribing rectangles are used as boundaries of different programmable readout windows of the image sensor for all objects, preferably a plurality of persons, that were acquired with the image sensor in full-image mode, in that the image sensor is switched to a repeating multiple partial-image recording mode with the determined circumscribing rectangles in the partial-image recording mode based on the currently adjusted plurality of readout windows, and image sequences of partial images having regions of interest of the objects that are read out successively so as to fill the image area are outputted.

In an advantageous manner, the repeating multiple partial-image recording mode ends and the image sensor is switched back to the full-image recording mode when at least one given object feature in one of the partial images has disappeared, so that the presence and position of the regions of interest of objects are determined once again in the full image in order that current regions of interest are outputted in a new repeating multiple partial-image mode so as to fill the image area.

In another advisable arrangement, the repeating multiple partial-image recording mode is ended after a predetermined time and the image sensor is switched back to the full-image recording mode so that the presence and position of the regions of interest of objects are determined anew in the full image in an ordered manner and current regions of interest are outputted in a new repeating multiple partial-image mode such that they fill the image area.

Further, in an arrangement for recording regions of interest of moving or changing objects, preferably of persons, containing a camera with an objective, an image sensor, a sensor control unit, an image storage unit and an image output unit, the object of the invention is met in that the objective is a wide-angle objective, in that the image sensor is a sensor with a variably programmable readout windows which has the full spatial resolution when reading out a programmed partial image, but has a substantially shorter readout time compared to the full-image readout mode and can be switched selectively between the full-image mode and partial-image mode, in that an image evaluating unit is provided for evaluating the full images recorded in the full-image mode, wherein the presence and the position of given defined object features can be determined from the full images and regions of interest are defined from the position of found object features in the form of circumscribing rectangles around the object features, and in that the image evaluating unit communicates with the image sensor by a sensor control unit in order to use the calculated circumscribing rectangles for variable control of the readout window in the partial-image mode of the image sensor. The wide-angle objective is advantageously a fixed-focus objective. The fixed-focus is advisably less than 1.5 m in front of the camera. However, an autofocus objective based on any type of operating principle can also be used as a wide-angle objective.

A high-resolution CMOS array is preferably used as an image sensor. However, CCD arrays with a corresponding window readout function are also suitable.

The invention has proven to be especially advantageous in that the image sensor (with full-image readout of all of its pixels) can have a low image rate without substantially impairing the required function even when it is required to provide a live image. Adaptation to any television standards or VGA standards can then be achieved in the full-image mode by reading out with a low pixel density (only every nth pixel in the row and column direction); in the partial-image mode, the required image repetition rate is surpassed in any case by reading out limited pixel areas.

The image evaluating unit preferably contains means for detecting faces of persons, or a face finder, as it is called.

It has proven advisable when the image evaluating unit has additional means for assessing the quality of found faces. For this purpose, means are advantageously provided for assessing the brightness of the read out partial image in relation to basic facial features and/or means are provided for assessing the size ratios of given object features. These latter measures are especially useful when recording a plurality of persons in the full visual field of the camera in order to select a limited quantity of faces by means of a multiple partial-image mode control. It can also be advantageous when an additional operation control unit is provided for influencing the image evaluating unit. The operation control unit has a clock cycle for cyclical switching of the image evaluating unit between full-image evaluations and partial-image evaluations in order to continuously update the evaluated objects or faces of persons with respect to the position and quality of the partial images and with respect to the new arrival of objects.

The fundamental idea of the invention is based on the consideration that the essential problem in live image cameras for electronic detection of faces of persons (e.g., for official identity documentation of persons or for identification in passport control) consists in that swivelable cameras with a zoom objective require a minimum period of time to achieve optimal directional adjustments and zoom adjustments for a high-resolution portrait. These camera adjustments—which are often carried out incorrectly—are avoided according to the invention by using a fixedly mounted camera with a wide-angle objective (preferably even with a fixed focal length). The electronic image sensor (optoelectronic converter) is coupled with means for defining a section of any size and any position from its complete image and subsequently outputting only this section as image. For this purpose, the position and size of this section are initially determined in the complete image by means of special image evaluating methods. The image sensor is then switched to the partial-image mode. In the partial image, the quality of the face is determined on the basis of image analysis criteria and—if necessary—other changes are made to the camera setting. Once the setting of the window (size, position) and of the other camera parameters (sensitivity, color matching) are optimal, the camera can then be operated in a live image mode and the face of a person can be displayed as a live image on the computer screen so as to fill the image area. If the person moves, this movement can be detected in the image and the position and size of the image section can be moved correspondingly.

The solution according to the invention makes it possible to obtain high-quality portraits of persons without the operator taking part in the recording process. This gives control personnel (e.g., at border stations) relief from distracting activity so that they can direct their attention to the person and documentation of that person.

The invention will be described more fully in the following with reference to embodiment examples.

### BRIEF DESCRIPTION OF THE DRAWINGS

In the drawings:

FIG. 1 schematically illustrates the method according to the invention;

FIG. 2 shows an advisable hardware variant for the full-image control and partial-image control for recording faces;

FIG. 3 shows the recording of a person according to the prior art; and

FIG. 4 shows the sequence of image acquisition when finding two (or more) significant object regions (multiple-image mode).

### DESCRIPTION OF THE PREFERRED EMBODIMENTSu

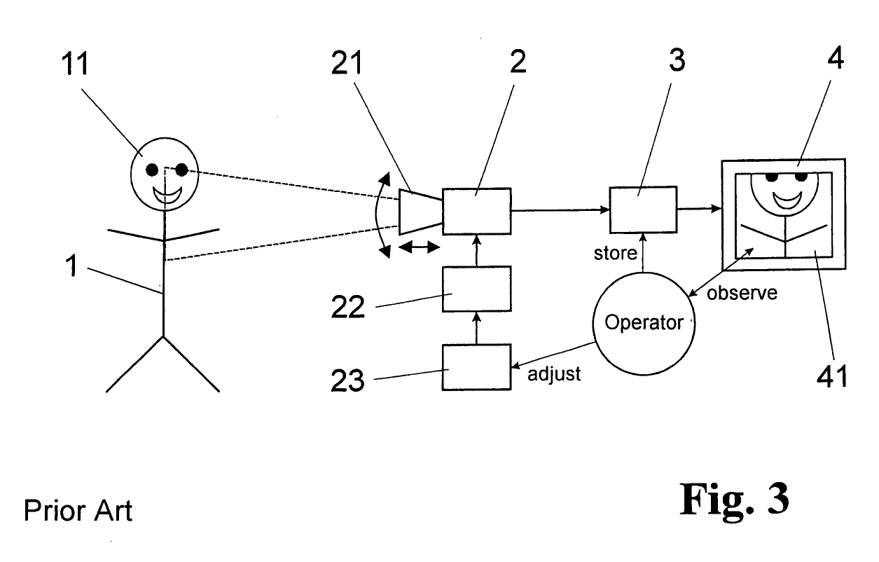

FIG. 3 shows an arrangement according to the prior art. The image recording is carried out by an operator (user of the system, e.g., police or customs official). A swivelable camera 2 with a zoom objective 21 is provided in order to record the face 11 of a person in the largest possible format (so as to fill the image area).

According to the view in FIG. 3, the camera 2 is oriented too low at the start and only a part of the face 11 is visible on the connected display unit 4 (computer screen). The operator detects this problem in the currently displayed image section 41 and operates the control keys at the control unit 23 interactively. The swiveling drive (only represented schematically by the curved double arrow and the drive control unit 22) then swivels the camera 2 upward. During this period, the camera 2 is constantly supplying new images with the fixed and unchangeable image dimension which are sent from the sensor chip of the camera 2 to an image storage 3. The sensor chip of the camera 2 operates, for example, according to the VGA format with 640 pixels horizontal and 480 pixels vertical and with an image repetition frequency of 25 images per second. An image of this kind is also known as a live image. The change in the camera image field during swiveling is only slightly delayed in a camera 2 operating at image repetition rates in the range of the conventional television standard (25 image per second), so that when the upward swiveling camera 2 acquires the face 11 of the person 1 being recorded in a centered manner the operator has the sense of immediately perceiving this on the screen 4. The control key of the control unit 23 associated with the swiveling drive is then released and the camera 2 is correctly oriented. The operator must then judge whether or not the face 11 is already visible on the screen 4 such that it fills up the image area and, if this is not the case, must narrow or widen the image field of the camera 2 in a suitable manner at the control unit 23 by means of a control key for the camera zoom drive (indicated only by the double arrow at the objective 21 and the drive control unit 22). When the operator thinks that the person 1 is placed optimally or at least adequately, the operator triggers the appropriate image storage which is to be used for identification or detection in a database.

Problems occur when both control processes (swiveling and zooming) must be carried out quickly and/or alternately because the person 1 is moving. Then, expectations for high-quality recording of the face 11 are quickly disappointed so that the subsequent process of comparison and cataloging is more complicated or, due to lacking resolution, can no longer be carried out in a definitive manner.

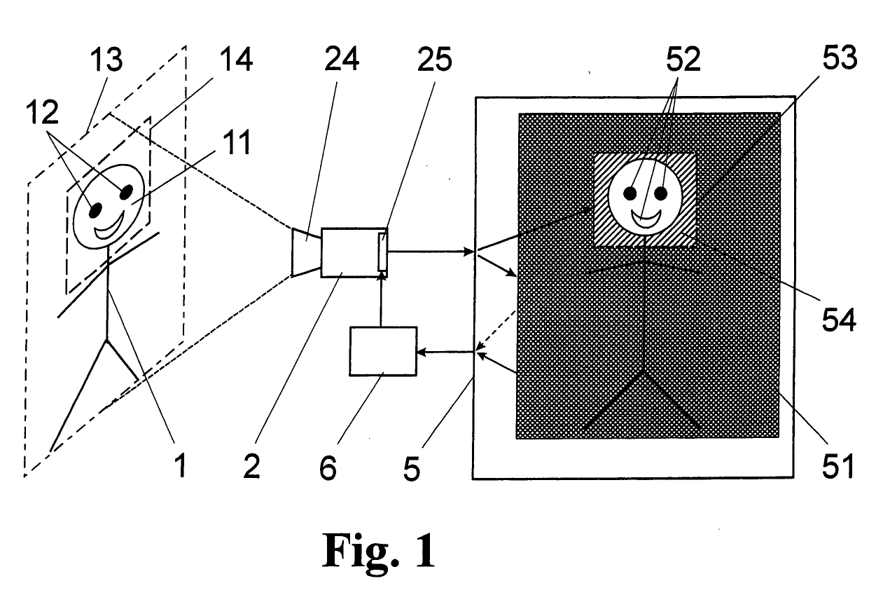

As is shown schematically in FIG. 1, the invention uses a camera 2 with a wide-angle objective 24 (preferably a fixed-focus objective) having an image sensor 25 which makes an overview recording of the imaged scene in the total image field 13 of the camera 2. The resolution of the image sensor 25 must be high enough so that it can meet the quality requirements for recording persons. In view of its image repetition speed (image rate), it can be an economical CMOS sensor which may not meet the television standard of 25 images/s in full image readout, but is able to adjust a WOI (Window of Interest), as it is called. In CMOS technology, depending on the manufacturer, this application is also called “region of interest” or “windowing”. In CCD technology, terms such as “fast dump” are used to signify skipping over rows and “overclocking” is used to signify overclocking of unnecessary columns. A typical example for a sensor of this kind in CMOS technology is the LM 9638 (manufactured by National Semiconductors, Inc., USA) with a readable total image size of 1280×1024 pixels.

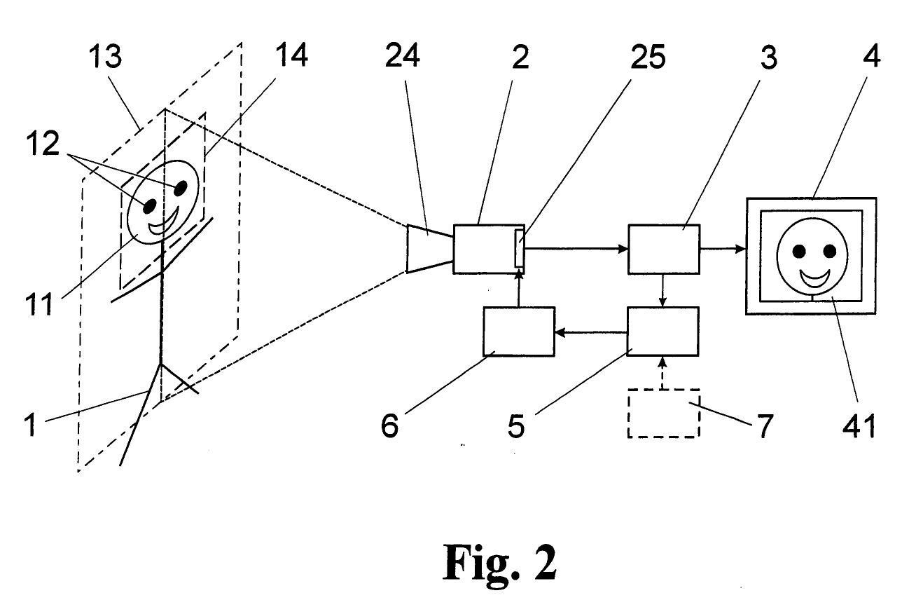

An image sensor 25 of the type mentioned above permits a partial image 54 to be read out at a faster rate (image rate) than the full image 51 of the image sensor 25. In this basic mode (full-image mode), the image sensor 25 initially provides a full image 51 with the full pixel quantity. The image repetition rate in this basic mode is comparatively low because a large quantity of pixels must be read out. When using the LM 9638, the pixel readout frequency is a maximum of 27 Mpixels/s, which gives only eighteen full images per second. The read out image reaches the image storage (shown only in FIG. 2) in digitized form from the image sensor 25 (with an integrated A-D converter if LM 9638 is used). In this example, the digital image storage 3 should contain a two-dimensional data field with the dimension of 1280×1024 data values. At a typical resolution of the digitization per pixel unit with 256 grayscale, every pixel is stored in a 1-byte data value and the image storage 3 is subsequently read out by two different units (display unit 4 and image evaluating unit 5).

As is shown in FIG. 2, a readout is carried out by means of the display unit 4 which visually displays the image on a screen in a known manner. It may be necessary to adapt the pixel dimensions of the read out image to the pixel dimension of the screen. This typically takes place in the display unit 4 itself with an integrated scaling process. Since this step is not significant for the present invention, it will not be described more fully.

The image is read out of the image storage 3 by an image evaluating unit 5 parallel to the screen display and is searched for the presence of a human face 11. Methods of this kind are known from the field of face detection and are classed under the heading of “face finders” in technical circles. Two methods are described, for example, in U.S. Pat. No. 5,835,616 (Lobo et al., “Face Detection Using Templates”) and in U.S. Pat. No. 6,671,391 (Yong et al.), “Pose-adaptive face detection system and process”).

Since many different face finder methods can be applied for realizing the invention, these methods are not discussed in greater detail; rather, it is merely assumed in the following that a suitable method of the kind mentioned above is applied to the stored image and—insofar as a face 11 is present in the image—the position of the face 11 in a read out full image 51 is outputted as results.

When the pixel coordinates are supplied as central coordinates of the significant object features 52 (e.g., images of eyes 12, nose and/or mouth in the human face) as the result of object detection methods of the kind mentioned above, a circumscribing rectangle 53 which contains the face 11 such that it fills the image area can be indicated in a suitable manner by calculating the coordinates of the upper-left and upper-right corners of the rectangle 53. Instead of this, it is also possible to use coordinates of the center points of the eyes 12 or of other features 52 by which the position of a face 11 can be described in a definitive manner and used for defining the pixel area of the image sensor 25 to be read out.

A circumscribing rectangle 53 enclosing the head outline or face 11 of a person 1 is generally appreciably smaller than the total image field 13 of the camera 2 (full image 51 of the completely read out image sensor 25) and makes it possible to read out a substantially smaller image section 14 of the object (partial image 54 as selected pixel field of the image sensor 25).

In this example—without limiting generality—the wide-angle objective 24 of the camera 2 is adjusted in such a way that the image sensor 25 is operated in vertical format (e.g., rectangular CMOS matrix, 1280 pixels high and 1024 pixels wide) and, in this way, a person (even a person whose height is greater than 2 meters) can be imaged in the image field of the camera 2 virtually in full size (but possibly omitting the legs). The distance of the person from the camera 2 can be predetermined for the most frequently used applications at at least 1.5 m, so that the wide-angle objective 24 can preferably be a fixed-focus objective for which all objects can always be sharply imaged starting from a distance of 1 m. However, autofocus objectives can also be used.

A face 11 that is present in the total image field 13 of the camera 2 could be, for example, 40 cm high and 25 cm wide and the circumscribing rectangle 53 could therefore be defined with this height and width as a pixel format on the image sensor 25. Accordingly, the pixel format to be read out for completely acquiring a face 11 is only 256 pixels in height times 160 pixels in width (in this example using the wide-angle objective 24 and the facial dimensions specified above). Since the quantity of pixels to be read out is considerably less than that for the full image 51, the image recording or image readout proceeds substantially faster than before. The image repetition frequency (image rate) is appreciably increased and can be adapted to any television standard or VGA standard.

In the next step, after determining the circumscribing rectangle 53, the adjustments for the position and size of the image section 14 are sent from the image evaluating unit 5 to a sensor control unit 6. On the one hand, the latter ensures that when the image sensor 25 is switched (from full-image readout to partial-image readout and vice versa), all operating conditions of the image sensor 25 are maintained and an image recording or image readout of the image sensor 25 that may possibly be running is not interrupted in an undefined manner at any time. On the other hand, the sensor control unit 6 is also responsible for writing the image sections (partial images 14), which are currently determined from the image evaluating unit 5 as circumscribing rectangle 53, into a register provided for this purpose in the image sensor 25 as a readout window (partial images 54) The image sensor 25 accordingly supplies full images 51 and partial images 54 that can constantly be evaluated. The latter may differ in size and position depending on the face detection in the image evaluating unit 5.

When the image sensor 25 is switched to the partial-image mode, it will detect only the currently adjusted pixel field from the entire image field 13 of the image sensor 25 (partial image 54) during the next image recording. This image recording or image readout takes place substantially faster than before because the quantity of pixels is considerably smaller. The image repetition frequency increases. Now, only current partial images are available in the image storage. As long as the coordinates of the partial image in the sensor are not readjusted, the camera supplies only images with this format and in this position, so that only the head (face) of the person found in the total image field of the sensor is displayed on the screen.

In a second variant for realizing the invention, the camera 2 is constructed in such a way that it contains all of the components, including the image storage 3, and the read out images are provided to a computer in digital form by means of an output unit 8 (e.g., a suitable data interface) instead of direct coupling of a display unit 4.

A camera 2 of this kind, like that already described, initially searches for faces 11 of persons 1 in the full image 51 and, as soon as a face 11 has been detected, switches the image sensor 25 to the partial-image mode. In the partial-image mode, the camera 2 supplies partial images 54 that contain a face 11 filling the image area. The readout unit 8 can be a standardized computer interface, e.g., Ethernet or USB.

In another arrangement, a method for tracking a moving face 11 in the partial image 54 is used in the image evaluating unit 5 in addition.

After the face 11 is found in the first step in the full-image mode and after then switching to the partial-image mode, it may happen that the person moves again and the face 11 therefore moves out of the area of the partial image 54. Naturally, this conflicts with the desired aim of recording the face such that it fills the image area.

Therefore, an algorithm is used in the image evaluating unit 5 for tracking the image section 14 or pixel coordinates of the partial image 54 which then determines in the partial-image mode where the face 11 is located and in what direction it is moving. If this algorithm detects that the coordinates of the object features 52 (e.g., center points of the eyes 12) used for calculating the circumscribing rectangle 53 have moved in a determined direction between two successive partial images 54, a correction of the coordinates of the circumscribing rectangle 53 and, therefore, of the partial image 54 in the pixel raster of the image sensor 25 is derived from the displacement of the object features 52 (preferably eyes 12) and the corrected coordinates are sent to the sensor control unit 6. The image sensor 25 subsequently detects the face 11 of the person 1 with the corrected coordinates and the face 11 accordingly remains completely (and so as to fill the image area) within the partial image 54 that is outputted in the display unit 4 or by the output unit 8.

However, it can also happen that the person exits from the total image area 13 (full image 51) of the camera 2. In this case, the circumscribing rectangle 53 reaches the outer edges of the full image 51 so that the partial image 54 that is read out cannot be displaced further relative to the full image 51 of the image sensor 25. Therefore, in another arrangement of the invention, it is checked whether the image edges of the partial image 54 have been reached or passed in relation to those of the full image 51 and, in such a case, the sensor control unit 6 switches back to the full-image mode again.

Accordingly, the image sensor 25 is read out again with its full pixel field (full image 51) and the image evaluating unit 5 begins anew to search for significant object features 52 of a face 11 in the next full image 51 that is read out. When this search is successfully concluded, the method advances to the point, already described, for reading out partial images 54.

In order to increase the image rate in the full-image mode, which amounts to only 18 images/s when reading out all pixels of the high-resolution image sensor 25 indicated above and is accordingly not capable of a television standard, it is advisable to operate in the full-image mode with a lower resolution, i.e., only every second or every fourth pixel of the rows and only every second or every fourth row in the full image 51 is read out. This leads to a decrease in the image resolution with respect to the total image field 13 when imaging the overview scene in full-image mode; but this reduced image resolution is quite acceptable for detecting features of a face 11 or other significant object features. In addition, this also leads to an advantage with respect to speed so that a higher image rate (e.g., that of the television standard) is achieved.

Further, it can also come about that a person 1 may be turned in such a way that the face 11 of the person 1 is no longer visible (or is not completely visible). In this case, most face finder algorithms detect that the face 11 is no longer present in the image. Based on these results of the image evaluation, the sensor control unit 6 switches the image sensor 25 back into the full-image mode and the image evaluating unit 5 will again search for the face 11 of the same person 1 or of another person in the full image 51 that is read out.

Uniform illumination of the face 11 of the person 1 can be very difficult in practice, for example, when no special lights can be provided for this purpose in the vicinity of the camera 2 and only the existing ambient light can be used. Situations in which the person 1 to be recorded is located in front of a very bright background, that is, with backlighting, are particularly difficult.

When the overview recording is adjusted over the total image field 13 (full image 51), the camera 2 would then adjust the sensitivity (shutter speed of the sensor, diaphragm of the objective, gain of the image signal) in such a way that an average brightness is achieved over all objects 1 in the full image 51. As a result, the face 11 of a person 1 can appear much too dark and details that are important for subsequent identification are made difficult to detect.

Therefore, in another arrangement, the image evaluating unit 5 is expanded in such a way that an additional step is taken in the running face detection algorithm (face finder) in which the existing brightness is determined in the face 11 that has already been found (omitting the background around the face 11). When this brightness diverges from a value that has been predetermined as optimal (e.g., too dark), suitable control information for the sensitivity adjustments of the camera 2 (diaphragm adjustment, electronic shutter speed control, and gain of the (sensor-integrated) A-D converter) are also determined in addition to the coordinates of the partial image 54 to be adjusted and is sent to the sensor control unit 6. The sensor control unit 6 accordingly adjusts the camera 2 to the new sensitivity so that the image section 14 that is recorded subsequently not only contains the face 11 such that it fills the image area, but also optimal brightness is achieved in reading out the partial image 54.

This principle can be expanded in such a way that the brightness is also constantly determined in the partial-image mode and, if necessary, the brightness adjustments of the camera 2 are tracked so that the face 11 is always in optimal brightness. This is especially important, in connection with the spatial tracking of the partial image 54 to be read out, when the person 1 moves and the image section 14 that is read out by tracked coordinates of the partial image passes over areas with illumination and backlighting of different brightness.

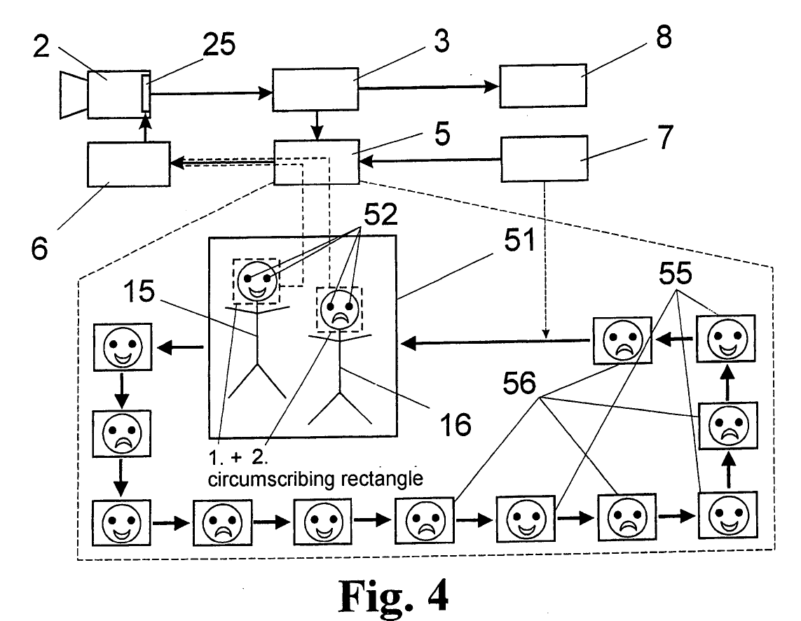

Another arrangement of the invention concerns a situation, according to FIG. 4, in which a plurality of persons 1 are located in the total image field 13 of the camera 2 (full-image mode). For this purpose, the image evaluating unit 5 can be supplemented over a conventional algorithm of a face finder (of any kind) in such a way that detected faces 11 are read out as results only when threshold values from additional predefined quality criteria are met. Quality criteria of this kind can be, e.g., a determined minimum size for faces 11 (i.e., they must be sufficiently close to the camera 2) or a defined visibility of the eyes 12 (i.e., the head is not turned to the side and the face 11 is directed approximately front toward the camera 2). In this connection, the maximum quantity of faces 11 to be found can be limited so that, for example, no more than three persons 1 are to be detected simultaneously and their faces recorded.

For this purpose, another step is integrated in the image evaluating unit 5 in which the quantity of faces 11 is determined initially in full-image mode and, insofar as there is more than the maximum permissible quantity, only the data of those faces 11 having the best quality (size, brightness, etc.) are further processed from the full image 51. A circumscribing rectangle 53 is then determined for each of these faces 11 as described in the preceding examples. This is followed by a processing routine that deviates from the procedure mentioned above.

Since only one image section 14 is selected in every readout of the image sensor 25, i.e., only one partial image 54 can be read out, the defined circumscribing rectangles 53 are supplied individually in succession as pixel presets by the sensor control unit 6 to the image sensor 25 repeatedly and a sequence of partial images 54 is read out (according to FIG. 4 only a sequence of two partial images 55 and 56) with different positions (and possibly different sizes).

This proceeds considerably faster than when the pixel format of the entire image sensor 25 is completely read out. The camera 2 can therefore be operated in a repeating multiple partial-image mode in which it supplies the partial images 55 and 56 of the two detected persons 15 and 16 in sequence corresponding to the example in FIG. 4. A first and second circumscribing rectangle 53 are associated, respectively, with the two persons 15 and 16 by means of their significant object features 52 and the imaged alternating sequence of first and second partial images 55 and 56 is formed from repeatedly writing them into the image sensor 25. Live images of the faces 11 of the detected persons 15 and 16 are conveyed to the image output unit 8 in that these first and second partial images 55 and 56 are stored in the image storage 3 in order and, as the case may be, can be displayed on separate monitors (display units 4, not shown in FIG. 4).

It is only when an interrupt criterion (person 1 has exited from the total image field 13 of the camera 2 or has turned around) has been detected in one of these partial images 55 and 56 that the image evaluating unit 5 switches back to the full-image mode and checks whether, in addition to the faces 11 still being tracked (sections 14), another person 1 is located in the total image field 13 of the camera 2 whose face 11 meets the quality criteria of the face detection. If this is the case, the corresponding new partial image 54 is also recorded in the multiple partial-image mode; otherwise, further operation proceeds with only the partial image 55 or 56 that was still present beforehand.

This routine can be modified such that the camera 2 regularly switches back, e.g., once every second, to the full-image mode in order to check for newly added persons 1. An operation control unit 7 used for this purpose contains a timer and, based on the latter, switches the image evaluating unit 5 cyclically between full-image evaluation and partial-image evaluation or interrupts the multiple partial-image mode after a determined quantity of partial images 54, 55 and 56.

While the foregoing description and drawings represent the present invention, it will be obvious to those skilled in the art that various changes may be made therein without departing from the true spirit and scope of the present invention.

Reference Numbers

1 object/person
11 face
12 eye
13 total image field (of the camera)
14 image section
15, 16 persons (different persons in one total image field)
2 camera
21 zoom objective
22 motor drive for swiveling and zooming
23 operator control unit for the motor drive
24 wide-angle objective
25 (high-resolution) image sensor
3 image storage unit
4 image display unit
41 current image section
5 image evaluating unit
51 full image
52 object feature
53 circumscribing rectangle
54 partial image
55 first partial image
56 second partial image
6 sensor control unit
7 operation control unit
8 image output unit

1. A method for recording regions of interest in moving or changing objects, preferably of persons, comprising the steps of:
tracking a region of interest of an object with an image that is read out of an image sensor for the output image so as to fill the image area; and further comprising the steps of:
operating the image sensor in such a way that it can be switched sequentially to a full-image mode and a partial-image mode, wherein a full image is recorded by a wide-angle objective as a stationary overview recording in the full-image mode and the region of interest of the object is recorded in the partial-image mode;
analyzing the full image acquired in the full-image mode by an image evaluating unit with regard to the presence and position of given object features, such as the face of a person, and determining a circumscribing rectangle around the region of interest of the object defined by the object features that are found from the position of the object features that are found;
using the currently determined circumscribing rectangle as a boundary of a programmable readout window of the image sensor; and
reading out, in partial-image mode, a sequence of partial images in which the region of interest of the object is contained so as to fill the image area at a high image rate based on the currently adjusted readout window of the image sensor.

2. The method according to claim 1, wherein partial images that are read out in partial-image mode are analyzed to determine whether there is any movement of given object features in successively read out partial images and, when it is determined that there has been a displacement of the object features, the position of the circumscribing rectangle is displaced in a matching manner in order to keep the region of interest of the object completely within the partial image (54) that is read out subsequently.

3. The method according to claim 2, wherein a switching back to the full-image mode is carried out when a border of the rectangle circumscribing the displaced partial image reaches or goes beyond the edge of the full-image recording, and the presence and position of the given object features are determined anew.

4. The method according to claim 2, wherein a switching back to the full-image mode is carried out when at least one object feature that is used to determine the circumscribing rectangle disappears from the partial image, and the presence and position of the given object features are determined anew.

5. The method according to claim 1, wherein the brightness of the object feature in the image is determined in addition to its position, a comparison is made to a reference brightness defined as optimal and, when there is a divergence from the reference brightness, adaptation is carried out by changing the sensitivity adjustments of the image sensor.

6. The method according to claim 5, wherein the gain of the A-D conversion of the image sensor signal is increased when a deficient brightness is determined in the read out partial image compared to the reference brightness.

7. The method according to claim 5, wherein the electronic shutter speed of the image sensor is changed when a deficient brightness is determined in the read out partial image compared to the reference brightness.

8. The method according to claim 5, wherein the electronic shutter speed of the image sensor is regulated and the gain of the A-D conversion of the image sensor signal is increased when a deficient brightness is determined in the read out partial image compared to the reference brightness.

9. A method for recording regions of interests of moving or changing objects, preferably of persons, comprising the steps of:
tracking a region of interest of an object so as to fill the image area for the output format with an image that is read out from an image sensor, and further comprising the steps of:
operating the image sensor so as to be switchable sequentially to a full-image mode and a partial-image mode, wherein a full image is made as a stationary overview recording in the full-image mode and the region of interest of the object is recorded in the partial-image recording mode;
analyzing the full image acquired in the full-image recording mode by an image evaluating unit for the presence and position of given defined object features, such as faces of persons, and circumscribing rectangles around the regions of interest of all found objects which are defined by the given object features are determined from the position of the given found object features;
using the currently determined circumscribing rectangles as boundaries of different programmable readout windows of the image sensor for all objects, such as a plurality of persons, that were acquired with the image sensor in full-image mode; and
switching the image sensor is switched to a repeating multiple partial-image recording mode with the determined circumscribing rectangles in the partial-image recording mode based on the currently adjusted plurality of readout windows, and image sequences of partial images having regions of interest of the objects that are read out successively so as to fill the image area are outputted.

10. The method according to claim 9, wherein the repeating multiple partial-image recording mode ends and the image sensor is switched back to the full-image recording mode when at least one given object feature in one of the partial images has disappeared, and the presence and position of the regions of interest of objects are determined once again in the full image in order that current regions of interest are outputted in a new repeating multiple partial-image mode so as to fill the image area.

11. The method according to claim 9, wherein the repeating multiple partial-image recording mode is ended after a predetermined time and the image sensor is switched back to the full-image recording mode, the presence and position of the regions of interest of objects are determined anew in the full image in order to output current regions of interest in a new repeating multiple partial-image mode such that they fill the image area.

12. An arrangement for carrying out the method according to claim 1, comprising:
a camera arrangement with an objective;
an image sensor;
an image sensor control unit;
an image storage unit; and
an image output unit;
said objective being a wide-angle objective;
said image sensor being a sensor with a variably programmable readout windows which has the full spatial resolution but a substantially shorter readout time compared to the full-image readout mode and can be switched selectively between the full-image mode and partial-image mode;
an image evaluating unit being provided for evaluating the full images recorded in the full-image mode;
wherein the presence and the position of given defined object features can be determined from the full images and regions of interest around the object features are defined from the position of found object features in the form of circumscribing rectangles; and
said image evaluating unit communicating with the image sensor by a sensor control unit in order to use the calculated circumscribing rectangles for variable control of the readout window in the partial-image mode of the image sensor.

13. The arrangement according to claim 12, wherein the wide-angle objective is a fixed-focus objective.

14. The arrangement according to claim 13, wherein the wide-angle objective (24) is a fixed-focus objective, wherein the focus is less than 1.5 m in front of the camera.

15. The arrangement according to claim 12, wherein the wide-angle objective is an autofocus objective.

16. The arrangement according to claim 12, wherein the image sensor is a high-resolution CMOS array.

17. The arrangement according to claim 12, wherein the image sensor (25) has a low image rate in the full-image readout of all pixels.

18. The arrangement according to claim 12, wherein the image evaluating unit contains means for detecting faces of persons.

19. The arrangement according to claim 18, wherein the image evaluating unit has additional means for assessing the quality of found faces.

20. The arrangement according to claim 19, wherein the image evaluating unit has means for assessing the brightness of the read out partial image in relation to basic facial features.

21. The arrangement according to claim 19, wherein the image evaluating unit has means for assessing the size ratios of given object features.

22. The arrangement according to claim 19, wherein an additional operation control unit is provided for influencing the image evaluating unit, wherein the operation control unit has a clock cycle for cyclical switching of the image evaluating unit between full-image evaluations and partial-image evaluations.

23. An arrangement for carrying out the method according to claim 9, comprising:
a camera arrangement with an objective;
an image sensor;
an image sensor control unit;
an image storage unit; and
an image output unit;
said objective being a wide-angle objective;
said image sensor being a sensor with a variably programmable readout windows which has the full spatial resolution but a substantially shorter readout time compared to the full-image readout mode and can be switched selectively between the full-image mode and partial-image mode;
an image evaluating unit being provided for evaluating the full images recorded in the full-image mode;
wherein the presence and the position of given defined object features can be determined from the full images and regions of interest around the object features are defined from the position of found object features in the form of circumscribing rectangles; and
said image evaluating unit communicating with the image sensor by a sensor control unit in order to use the calculated circumscribing rectangles for variable control of the readout window in the partial-image mode of the image sensor.

24. The arrangement according to claim 23, wherein the wide-angle objective is a fixed-focus objective.

25. The arrangement according to claim 24, wherein the wide-angle objective (24) is a fixed-focus objective, wherein the focus is less than 1.5 m in front of the camera.

26. The arrangement according to claim 23, wherein the wide-angle objective is an autofocus objective.

27. The arrangement according to claim 23, wherein the image sensor is a high-resolution CMOS array.

28. The arrangement according to claim 23, wherein the image sensor (25) has a low image rate in the full-image readout of all pixels.

29. The arrangement according to claim 23, wherein the image evaluating unit contains means for detecting faces of persons.

30. The arrangement according to claim 29, wherein the image evaluating unit has additional means for assessing the quality of found faces.

31. The arrangement according to claim 30, wherein the image evaluating unit has means for assessing the brightness of the read out partial image in relation to basic facial features.

32. The arrangement according to claim 30, wherein the image evaluating unit has means for assessing the size ratios of given object features.

33. The arrangement according to claim 30, wherein an additional operation control unit is provided for influencing the image evaluating unit, wherein the operation control unit has a clock cycle for cyclical switching of the image evaluating unit between full-image evaluations and partial-image evaluations.
